(19) United States
(12) Patent Application Publication
(10) Pub. No.: US 2026/0253765 A1
(43) Pub. Date: Aug. 27, 2026

(54) A Cable Gland

(71) Applicant: CCG SOUTH EAST ASIA PTE LTD, Singapore (SG)

(72) Inventor: Geoffrey Ingles Mood, Whitley Bay, Tyne and Wear (GB)

(21) Appl. No.: 19/478,056

(22) PCT Filed: Apr. 15, 2024
(86) PCT No.: PCT/IB2024/053679

§ 371 Date: Oct. 23, 2025

(30) Foreign Application Priority Data
Apr. 17, 2023 (GB) 2305612.0

(51) Int. Cl. H01B 17/30

(52) U.S. Cl. CPC H01B 17/303

(57) ABSTRACT

A cable gland is provided. The cable gland comprises a first gland component, a second gland component and a nut. Both of the first gland component and the second gland component have inner surfaces which define tubular cavities configured to receive a cable and outer surfaces having threaded portions near first ends thereof. The nut includes a threaded inner surface wherein at least a portion of the threaded inner surface corresponds to the thread on the first gland component and at least a portion thereof corresponds to the thread on the second gland component. The two gland components are connectable together by aligning and contacting the first ends of the two gland components and engaging the thread of the nut with the thread of both of the gland components.

### CROSS-REFERENCE TO RELATED APPLICATION

This application claims priority from United Kingdom patent application number No. 2305612.0 filed on 17 Apr. 2023, which is incorporated by reference herein.

### FIELD OF THE INVENTION

This invention relates to a cable gland, more particularly, to a cable gland including a locking arrangement such that the cable gland may be at least partially disassembled whilst remaining locked to a cable.

### BACKGROUND TO THE INVENTION

Cable glands generally comprise a number of components connectable together to make up the cable gland. Whilst in use, the components may be connected together, and a cable may be clamped within a tubular cavity of the cable gland.

In some instances, it is advantageous for at least a component of a cable gland to remain clamped to a cable whilst the cable gland itself is partially disassembled. For example, in a barrier cable gland, a main gland assembly might be removed from an entry component of the barrier cable gland to allow for a barrier material, which may be a liquid resin, to be installed. In such a situation, it is a significant advantage for the cable to remain clamped to at least of portion of the barrier cable gland so that it remains correctly aligned as the barrier material cures.

One method of allowing the cable gland to be assembled and disassembled is to provide a coupling nut disposed between the two or more components which are to be separated relative to each other. For example, a coupling nut may be disposed between a main gland assembly and an entry component thereof. The coupling nut includes a section which engages a collar on the main cable gland assembly and a threaded section which engages a corresponding threaded section on the entry component.

This method has the disadvantage that in the assembled configuration the coupling nut is unable to prevent the main cable gland assembly (i.e., the component which remains clamped to the cable) from rotating relative to one or more other components, such as the entry component, if a torque is applied to it, for example when tightening an outer seal of the cable gland. In the case of cable glands, this is a significant problem as it could mean that the cables installed in the cable gland could become twisted. Cable glands that have bodies that can be moved rotationally may also fail routine inspections. Cable glands which are for use in hazardous areas may also need to sustain a torque test during certification and this will not be possible if the body is able to rotate relative to the entry component.

Two existing solutions to this problem are currently available.

A first solution is to use corresponding splines and grooves on the two or more components which are to be separated, for example, as disclosed in Terminator II™ TMCX armored cable glands produced by Eaton™. For example, corresponding splines and groves may be incorporated into the main cable gland body and the entry component respectively so that they engage to prevent rotation. A coupling nut then holds the main cable gland body and the entry component together. Although this is an effective solution, it has the disadvantage that forming the splines and grooves can be an expensive process unless special broaching tools are purchased. If broaching tools are used, then their use is an extra machining operation and does not allow easy flexibility for change. It may also require the cable gland diameter and the coupling nut diameter to become larger to accommodate the splines and grooves, which may increase material required to make the gland and consequently the cost of the gland too.

A second solution is to use one or more lug(s) and mating groove(s) on the two or more components which are to be separated, for example, as disclosed in TMCX type cable glands produced by CCG™. For example, one or more lug(s) may be incorporated into the main cable gland body and one or move corresponding groove(s) may be incorporated onto the entry component, or vice versa, so that they engage to prevent rotation. A coupling nut holds the main cable gland and the entry component together. As with the first solution, this solution also has the disadvantage that it requires extra machining stages. However, as the mating connection is axial rather than radial it does not require the cable gland diameter to be increased. It also allows the gland body to be located in the exact same rotational position when reassembling the cable gland assembly.

There is accordingly scope for improvement.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with an aspect of the invention there is provided a cable gland comprising:
a first gland component having an inner surface defining a tubular cavity configured to receive a cable and an outer surface including a threaded portion near a first end thereof;
a second gland component having an inner surface defining a tubular cavity configured to receive a cable and an outer surface including a threaded portion near a first end thereof;
a nut including a threaded inner surface wherein at least a portion of the threaded inner surface is configured to correspond to the thread on the first gland component and at least a portion of the threaded inner surface is configured to correspond to the thread on the second gland component;
wherein the first gland component is connectable to the second gland component by aligning and contacting the first end of the first gland component with the first end of the second gland component and engaging the thread of the nut with the thread of both of the gland components.

The nut may be dimensioned to slidably receive the first and second gland components. The nut may include a restriction adjacent to the threaded inner surface of the nut configured to engage with the second gland component. The restriction may be an annular restriction. The restriction may be located at an end which is configured to engage with the second gland component. The restriction may be configured to prevent the nut from being rotated beyond a predefined point of the second gland component.

The threaded portion of the second gland component may be configured such that when the nut is engaged therewith axial rotation of the nut results in movement of the nut relative to the first end of the threaded portion of the second gland component.

The threaded portion of the second gland component may be configured to be a threaded collar having a diameter that is greater than a diameter of a portion of the second gland component which is positioned adjacent to the threaded collar such that the threaded collar is raised relative to the adjacent portion of the second gland component.

The restriction of the nut may be configured to have an internal diameter which is less than that of the threaded collar of the second gland component and greater than that of the adjacent portion of the second gland component such that the restriction prevents movement of the nut in the direction of the first end of the second gland component when the restriction butts against the threaded collar.

The nut may be configured to engage with and extend along the entirety of the threaded portion of the second gland component and at least a part of the threaded portion of the first gland component when the annular restriction butts against the threaded collar thereby securing the first gland component and the second gland component together. The sum of the axial dimension of the threaded portion of the first gland component and the axial dimension of the threaded portion of the second gland component may be greater than the axial dimension of the threaded inner surface of the nut.

The cable gland may include a seal nut which cooperates with a seal to secure a cable within the tubular cavity of the second gland component, wherein the cable and the second gland component may become locked relative to each other when the outer seal is tightened. The seal nut may be a compression seal nut and the seal may be a compression seal such that compression of the compression seal results in radial inward expansion thereof.

The cable gland may further include a resin pot component, the resin pot component being shaped and dimensioned to locate within the internal cavities of the first and second gland components and having a closable end configured to seal onto a cable sheath of the cable when the cable is secured within the cable gland.

Rotation of the second gland component in a loosening direction may result in a disengagement of the threading of the first gland component with the threading of the nut to result in a disconnection between the first gland component and the second gland component.

The resin pot component may be held within the internal cavity of the second gland component when the first and second gland components are disconnected, such that the resin pot component is in an accessible position. The resin pot component may operatively receive a barrier material therein when in the accessible position. The barrier material may be a resin mix.

The first gland component may be an entry component, and the second gland component may be a gland body component.

The entry component may include a protrusion configured to facilitate movement of the entry component.

An outer surface of the nut may form a hexagonal shape to facilitate rotation thereof. Similarly, an outer surface of the protrusion may form a hexagonal shape to facilitate rotation thereof.

The threaded portion on the outer surface of the first cable gland component may commence at the first end thereof. The threaded portion on the outer surface of the second cable gland component may commence at the first end thereof.

Embodiments of the invention will now be described, by way of example only, with reference to the accompanying drawings.

### BRIEF DESCRIPTION OF THE DRAWINGS

In the drawings:

FIG. 1 is a perspective sectional view of a cable gland in an assembled configuration;

FIG. 2 is a front sectional view of the cable gland of FIG. 1;

FIG. 3 is a perspective sectional view of the cable gland of FIG. 1 in a disassembled configuration, illustrated as having an entry component thereof removed;

FIG. 4 is a front sectional view of the cable gland of FIG. 3;

FIG. 5 is a partially exploded perspective view of a cable gland;

FIG. 6 is a partially exploded side view of the cable gland of FIG. 5;

FIG. 7 is an exploded perspective view of a cable gland;

FIG. 8 is an exploded side view of the cable gland of FIG. 7; and

FIG. 9 is a front sectional view of a second embodiment of a cable gland in an assembled configuration.

### DETAILED DESCRIPTION WITH REFERENCE TO THE DRAWINGS

Aspects of the present disclosure provide a cable gland which includes components which interact to result in a locked condition of the cable gland which facilitates continued clamping of a cable within the cable gland whilst the cable gland is partially disassembled. Aspects of the present disclosure provide for such a cable gland to include a first gland component, a second gland component, and a nut dimensioned to engagedly receive the first and second gland components. The first gland component may include an inner surface which defines a tubular cavity configured to receive a cable and an outer surface including a threaded portion at or near a first end thereof. The second gland component may include an inner surface which defines a tubular cavity configured to receive a cable and an outer surface including a threaded portion at or near a first end thereof.

The thread of the first gland component and the thread of the second gland component may be of the same configuration. In this manner, with the first ends of each gland component being axially aligned and contacting each other, and with the gland components at the appropriate rotational offset relative to each other, the thread of the first gland component can form a continuation of the thread of the second gland component.

The nut may include a threaded inner surface wherein at least a portion of the threaded inner surface is configured to correspond with the thread on the first gland component and at least a portion of the threaded inner surface is configured to correspond to the thread on second gland component. The first gland component may therefore be connectable to the second gland component by aligning and contacting the first ends of the two gland components and engaging the thread of the nut with the thread of both of the gland components. The threading on the first gland component, second gland component and nut may be a screw threading. In some embodiments, the threading of the first gland component, second gland component and nut may be of the same configuration, for example having cooperating thread pitch, threads per inch, pitch diameter, flank angle and the like. In some embodiments, the portion of the threaded inner surface being configured to correspond with the thread of the first gland component may be a continuation of the portion of the threaded inner surface being configured to correspond to the thread of the second gland component. In this manner, the two inner threaded portions of the nut may be one and the same.

The nut, according to aspects of the present disclosure, may include a restriction adjacent to the threaded inner surface of the nut. The restriction may be configured to prevent or prohibit movement of the nut along the second gland component beyond a certain limit (or predefined point). The restriction may be in the form of an annular restriction or may take on another form. The restriction may locate at one end of the nut. More specifically, the restriction may locate at the end of the nut which is configured to engage with the second gland component. The threaded inner surface of the nut may extend from the restriction to an opposite end of the nut. The threaded portion of the second gland component may be configured such that when the nut is engaged therewith axial rotation of the nut results in movement of the nut along an axis thereof relative to the first end of the threaded portion of the second gland component. This restriction is configured to prevent the nut from being rotated beyond a predefined point of the second gland component. The predefined point of the second gland component may be an inner edge (or an innermost extent) of the threaded portion of the second gland component which is opposite an outer edge (or outermost extent) of the threaded portion of the second gland component. The outer edge (or outermost extent) of the threaded portion locates at or near the first end of the second gland component and the threaded portion of the second gland component extends between these inner and outer edges. In some embodiments, the threaded portion of the second gland component commences at the first end thereof. Similarly, in some embodiments, the threaded portion of the first gland component commences at the first end thereof. In this manner, in some embodiments, when placed in end-to-end engagement with each other and with appropriate alignment, the threaded portion of the first gland component is a continuation of the threaded portion of the second gland component.

The threaded portion of the second gland component may have a major diameter, defined by the thread crests, which exceeds or is greater than a diameter of an adjacent portion of the second gland component. In some embodiments, the threaded portion of the second gland component may be provided by a threaded collar having a major diameter defined by the thread crests (e.g. a maximum extent of the diameter of the threaded portion) which is greater than an outermost diameter of a portion of the second gland component which is positioned adjacent to the threaded collar. In this manner, the threaded collar may be said to be raised relative to the adjacent portion of the second gland component. When the first ends of the two gland components are aligned and engaged with the thread of the nut, and the nut is positioned such that the restriction prevents further movement thereof relative to the second gland component, the first gland component and the second gland component will be arranged in a locked configuration relative to each other and to the nut.

The term “locked” or “locking condition” as used herein should be broadly construed as to mean substantially fixed in a given configuration. In other words, when one or more component of the cable gland is locked, as described herein, the component(s) will not be movable without external intervention thereof.

The threading of the second gland component may be configured such that rotation of the nut in a tightening direction results in movement of the nut in the direction of (i.e. along the axis towards) the first end of the second gland component. When the first end of the first gland component and the first end of the second gland component are aligned and contacted, the nut may be threadedly engaged with the second gland component such that axial rotation in the tightening direction results in movement of the nut towards the first gland component and subsequent engagement of the threading of the nut with both of the threaded collar of the second gland component and the threaded portion of the first gland component. Continued rotation of the nut about the axis in the tightening direction will result in this movement along the axis until the restriction of the nut butts against the raised threaded collar of the second gland component, at which point movement of the nut in the tightening direction is locked. Engagement of the nut with both of the first and second gland components facilitates a locking condition of the cable gland.

The size of the nut may be configured such that when the restriction of the nut butts against the raised threaded collar of the second gland component, a width of the nut spans the extent of the threaded portion of the second gland component along the axis thereof (i.e. a width of the threaded portion of the second gland component) and at least a part of the extent of the threaded portion of the first gland component along the axis thereof (i.e. a width of the threaded portion of the first gland component). In one embodiment, the widths of the threaded portions of the first and second gland components are selected such that, when the first ends of the two components contact each other, the sum of the widths exceeds the width of the threaded portion of the nut. In an alternate embodiment, the sum of the widths of the threaded portions of the first and the second gland components may be less than the width of the threaded portion of the nut. In such an embodiment, first gland component includes a non-threaded portion adjacent to the threaded portion thereof, wherein the non-threaded portion has an external diameter that is smaller than the external diameter of the threaded portion. This may ensure proper locking of the gland components and nut because it can be ensured that the restriction of the nut is brought to bear against the raised threaded collar of the second gland component.

The outer surface of the second gland component may include a non-threaded portion adjacent to the threaded portion. In other words, a portion of the outer surface of the second gland component adjacent the threaded portion may be non-threaded. In some embodiments, the non-threaded portion may be a substantially smooth surface having an outermost diameter which is less than an outermost diameter of the threaded portion. In this manner, the threaded collar of the second gland component is raised relative to this non-threaded portion. This configuration allows for a radial extent of the restriction (e.g., being the diameter of the annular restriction) of the nut to be as small as possible to allow for an optimized engagement between the restriction and the second gland component, so as to increase the strength of this area. In a further embodiment, the outer surface of the second gland component may include a second threaded portion adjacent to the threaded collar. The nut may then be configured to have two threaded inner surface portions: a first threaded portion configured to engage with the threaded collar of the second gland component and the threaded portion of the first gland component, and the second threaded portion of the nut being positioned on an inner surface of the restriction configured to engage with the second threaded portion of the second gland component. The threaded collar and the second threaded portions of the second gland component may be separated by a non-threaded portion. This configuration may have the advantage of enabling the effective diameter of the restriction of the nut to be reduced, thereby providing for a greater engagement of the nut with the second gland component to increase the strength of such an engagement.

The second gland component may include a second end, opposite to the first end thereof, which may be referred to as the sealing end of the second gland component.

The cable gland may further include a seal nut which cooperates with a seal to secure a cable within the tubular cavity of the second gland component. In an embodiment, this seal nut may be a compression seal nut and the seal may be a compression seal such that compression of the compression seal results in radial inward expansion thereof. Therefore, the cable and the second components may become locked relative to each other when the compression seal nut is tightened. The compression seal may be an elastomeric member configured to fit within the second end of the tubular cavity of the second gland component. The compression seal nut may be operable to compress the elastomeric member to cause radial inward expansion in a known fashion. The compression seal nut may have a screw threaded portion within a bore of the compression seal nut which cooperates with a threaded portion on the sealing end of the second gland component.

The cable gland may further include a resin pot component, the resin pot component being shaped and dimensioned to locate within the internal cavities of the first and second gland components and having a closable end configured to seal onto a cable sheath of the cable when the cable is secured within the cable gland. The resin pot component may be held within the internal cavity of the second gland component when the first and second gland components are disconnected, such that the resin pot is in an accessible position. The resin pot component may operatively receive a barrier material therein when in the accessible position and this barrier material may be a resin mix.

Rotation of the nut in a loosening direction relative to the first gland component may result in a disengagement of the threading of the first gland component with the threading of the nut to result in a disconnection between the first gland component and the second gland component. In the case of right-hand threading, this loosening rotation of the nut would be rotation in an anti-clockwise direction, and conversely, in the case of left-hand threading, this loosening direction would be rotation of the nut in a clockwise direction. It is this rotation which enables the partial disassembly of the cable gland.

The first and second gland components may be any two of the components which make up a gland component. In some embodiments, the first gland component may be an entry component and the second gland component may be a gland body component.

The overall shape of the gland component may be substantially cylindrical in shape. An outer surface of the nut may form a hexagonal shape to facilitate rotation thereof, and similarly, an outer surface of the protrusion may also form a hexagonal shape to facilitate rotation thereof.

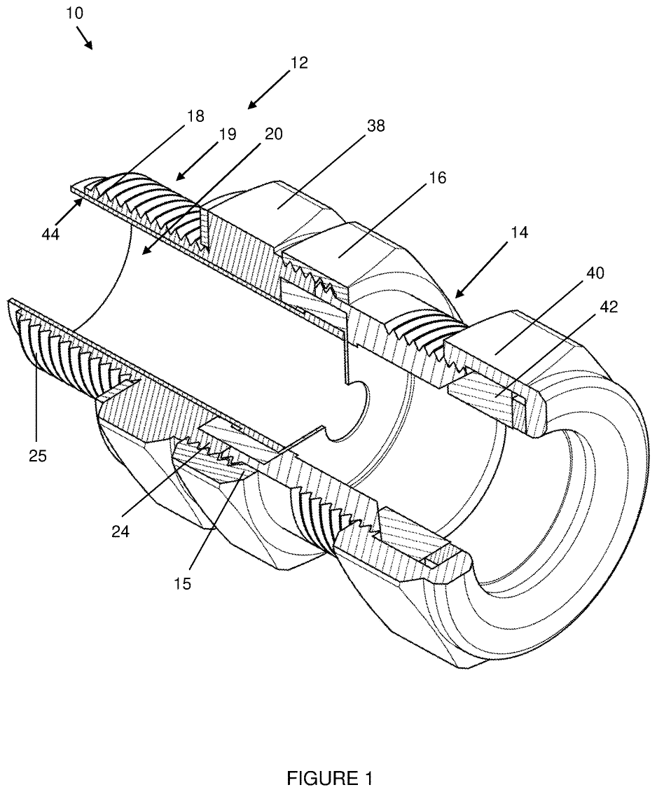

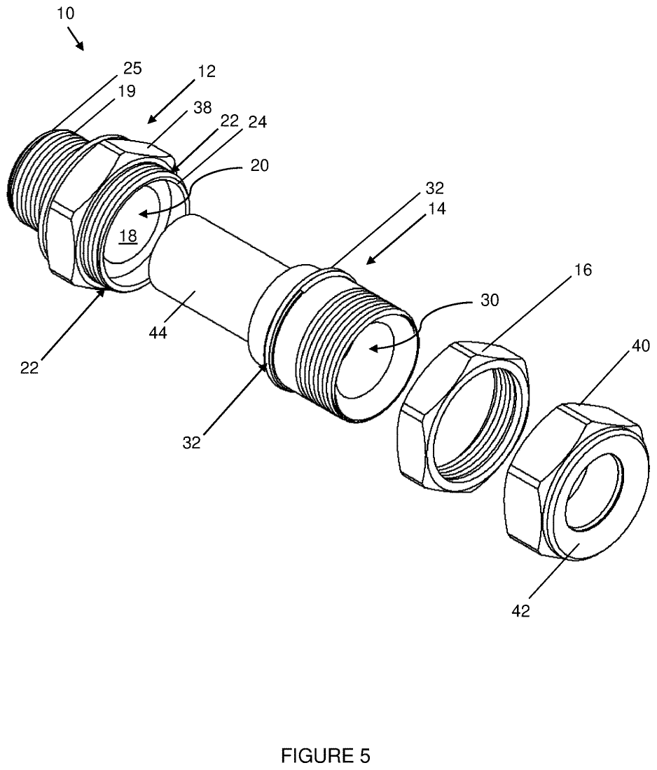

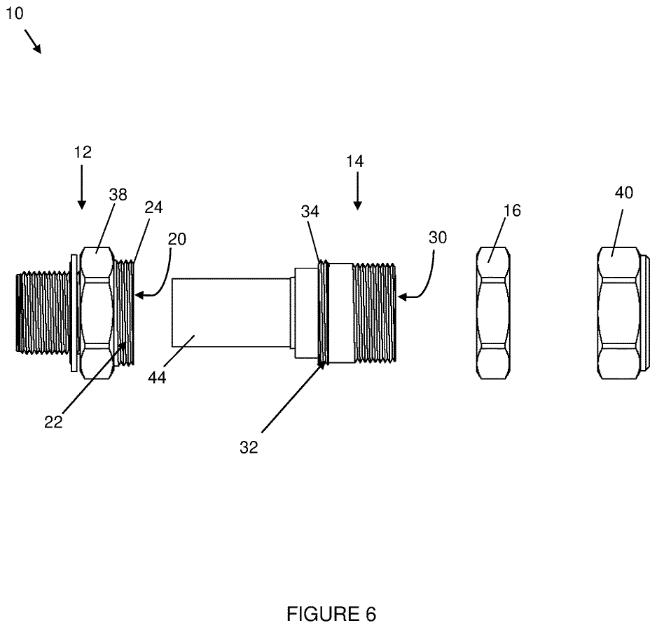

FIGS. 1 to 8 illustrate an example embodiment of the above described cable gland according to aspects of the present disclosure.

The cable gland (10) comprises a first gland component (12) and a second gland component (14). In the illustrated embodiment, the first gland component is an entry component (12), and the second gland component is a gland body component (14). In other embodiments, these components may refer to other components which make up a cable gland. The first and second gland components (12, 14) may be locked together by means of a nut (16).

The entry component (12) as shown most clearly in FIG. 1, comprises an inner surface (18) and an outer surface (19). The inner surface (18) defines an internal cavity (20) which is substantially tubular in shape. The tubular cavity (20) may be configured to operatively receive a further component of the cable gland (10) or a cable itself. In the illustrated embodiment, the internal cavity (20) operatively receives a resin pot component (44). The entry component (12) comprises a first end (24) and a second end (25). The second end (25) is configured to connect the entry component (12) to any suitable article or surface to which a cable is to enter or attach to. For example, the entry component (12) may be configured to connect the cable gland (10) to a junction box or other piece of electrical equipment. Therefore, the second end (25) of the entry component (12) may include a connection means. For example, and as illustrated in this embodiment, the second end (25) of the entry component (12) includes a threaded outer surface (19) which enables the entry component to be screwed into electrical equipment which includes a bore having corresponding thread.

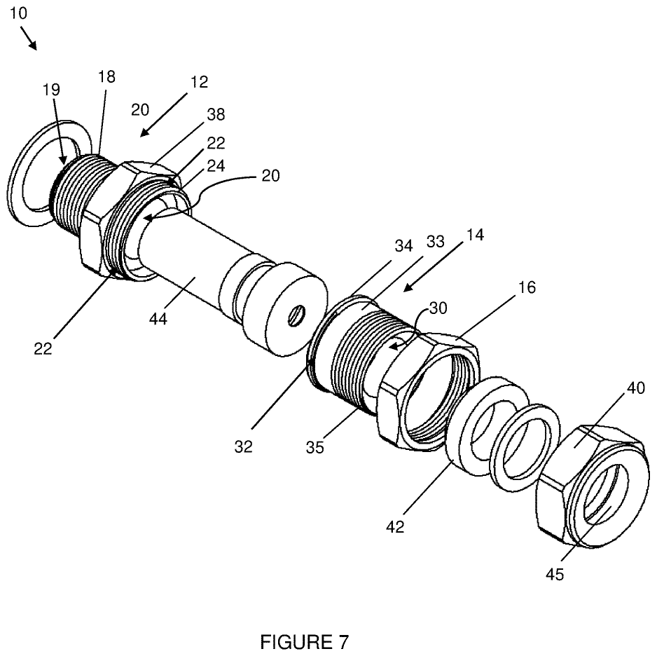

The first end (24) of the entry component (12) includes a threaded portion or collar (22), as shown most clearly in FIG. 7. In the illustrated embodiment, threaded portion or collar (22) commences at and extends away from the first end (24) of the entry component (12). In the illustrated embodiment, the threaded collar (22) is adjacent to a protrusion (38) which locates in between the threaded collar and the threaded outer surface (19) forming the connection means. The protrusion (38) extends around the circumference of the external surface (19) of the entry component (12). The protrusion (38) may have a hexagonal outer surface to facilitate rotation of the entry component (12), with the likes of a wrench or a similar tool. This outer surface may be shaped in any other suitable shape to facilitate rotation in other embodiments of the cable gland. The entry component (12) may be machined from a metallic tube, a block of metal or the like. The entry component may therefore be integrally formed (i.e. formed as a single, one-piece component).

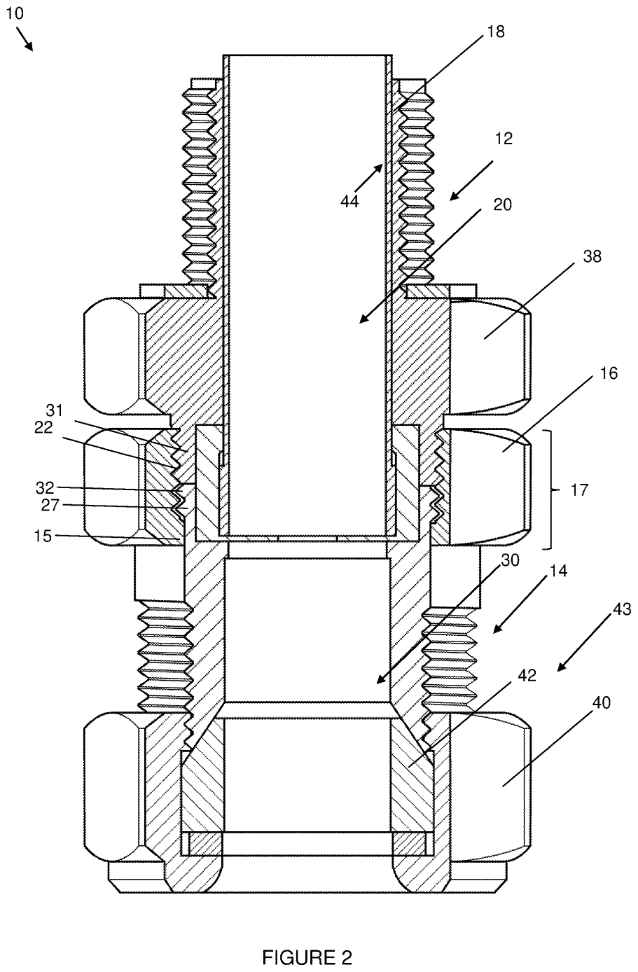

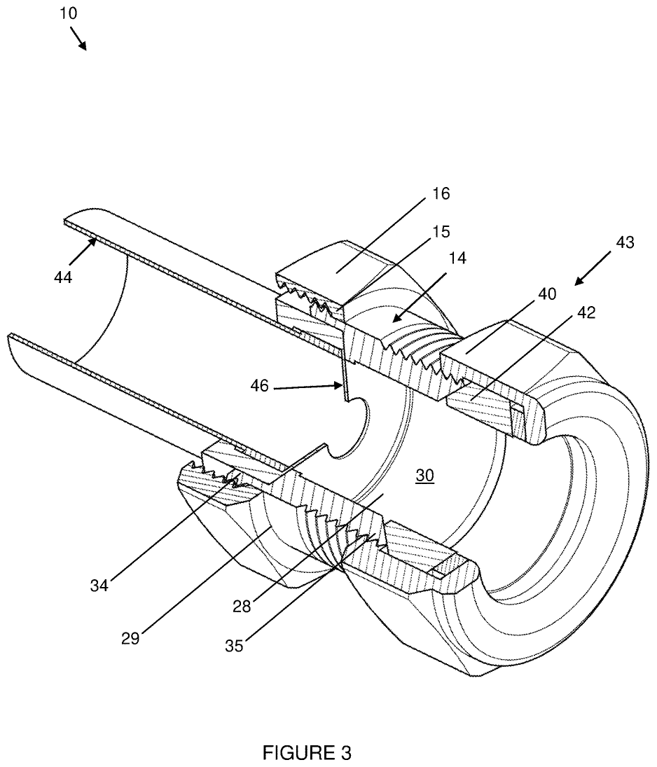

The gland body component (14) as shown most clearly in FIGS. 3 and 7 comprises an inner surface (28) and an outer surface (29). The inner surface (28) defines an internal cavity (30) which is substantially tubular in shape. The tubular cavity (30) may be configured to operatively receive a further component of the cable gland (10) or a cable itself. In the illustrated embodiment, as illustrated in the figures, part of the internal cavity (30) operatively receives an end of a resin pot component (44). As is shown most clearly in FIG. 2, the tubular cavity (30) of the gland body component (14) includes an enlarged portion (27) of the tubular cavity (30) at the first end of the gland body component and configured to receive the end of the resin pot component (44). In some embodiments, only the gland body component is sized and dimensioned to receive this end of the resin pot component. In the embodiment illustrated in FIG. 2, however, the entry component (12) is also configured to receive the resin pot component (44) and the tubular cavity (20) thereof also includes an enlarged portion (31) at the first end of the entry component and having a radius that is larger than an adjacent portion of the tubular cavity (20). The enlarged portions may have the same radiuses as each other and may be shaped and dimensioned to receive together a compression seal forming part of the resin pot component. This compression seal is configured to retain barrier material in the resin pot component while the barrier material cures. In alternate embodiments the resin pot may not include a compression seal. The gland body component (14) comprises a first end (34) and a second end (35). The second end (35) is configured to connect the gland body component (14) to a further cable gland component. In the illustrated embodiment, the second end (35) is configured to connect to a sealing arrangement (43). Therefore, the second end (35) of the entry component (12) may include a connection means. For example, in the illustrated embodiment, the second end (35) of the gland body component (14) includes a threaded outer surface which enables the sealing arrangement (43) to be connected to the gland body component by screwing the two corresponding threads together.

The first end (34) of the gland body component (14) includes a threaded portion or collar (32), as shown most clearly in FIG. 7. In the illustrated embodiment, the threaded portion or collar (32) commences at and extends away from the first end (34) of the gland body component (14). In the illustrated embodiment, the threaded collar (32) is adjacent to a non-threaded portion (33). In other embodiments the threaded collar may be positioned adjacent to a further threaded portion of the gland body component (14). In the illustrated embodiment, the non-threaded portion has a smooth surface. The smooth surface (33) has an outermost circumference selected such that the threaded collar (32) is raised relative to the smooth surface (33). This sizing allows the nut (16) to slidably receive the gland body component (14) from the second end (35) thereof and be screwed into the corresponding thread on the threaded collar (32) at the first end (34) thereof. The gland body component (14) may be machined from a metallic tube, a block of metal or the like. The gland body component may therefore be integrally formed (i.e. formed as a single, one-piece component).

In the illustrated embodiment, the threaded portion or collar (22) of the entry component has a diameter that is the same as the diameter of the threaded portion or collar (32) of the gland body component (14). Therefore, when the first ends (24, 34) of the entry component (12) and gland body component (14) are aligned and contacted, the two threaded collars (22, 32) will together form a continuous threaded portion.

The cable gland (10) includes a nut (16). In particular, the nut (16) may be a coupling nut, although any other suitable nut may be used. The nut (16) is dimensioned to engagedly receive the threaded collars (22, 32) of the entry component (12) and the gland body component (14).

The nut (16) includes an annular restriction (15) at one end thereof. The nut (16) is configured to engage with the gland body component (14) in an orientation such that the annular restriction (15) is configured to prevent the nut (16) from being rotated beyond a predefined point of the gland body component (14). This annular restriction (15) is dimensioned to receive the non-threaded portion of the gland body component (14) and move towards the predefined point where movement will no longer be possible. This movement may be described as movement in the tightening direction. In the illustrated embodiment, the predefined point is the threaded collar (32) and movement of the nut will be hindered by the annular restriction (15) butting against the threaded collar (32). Therefore, when the nut is threadedly engaged with the second gland component (14) and rotated in a tightening direction, rotation and subsequent movement of the nut (16) along an axis of the gland will be possible until the annular restriction (15) butts against the threaded collar (32) and movement will no longer be possible. This configuration may be termed a “locked configuration” of the nut (16) and the gland body component (14).

The threading on each of the entry component (12), the gland body component (14) and the nut (16) is configured such that the nut (16) may be engaged with both of these gland components (12, 14). When the nut (16) is engaged with the gland body component (14) in the locked configuration, the gland body component (14) may be connected to the entry component (12) by engaging the nut (16) with the threading of the entry component (12), whilst the nut (16) is already engaged with the gland body component (14). The nut (16) and the gland body component (14) may be rotated relative to the entry component (12) in a tightening direction until the first end of the gland body component (14) butts against the first end of the entry component (12), within the nut. In the illustrated embodiment, the tightening direction is a clockwise direction. When the entry component (12) and the gland body component (16) are positioned adjacent to each other in this configuration, the gland body (10) will be in a locked configuration. Therefore, the gland body component (14) will be prevented from rotating any further clockwise (in the tightening direction) as the threaded connection between it and the nut (16) forces it to lock up against the entry component (12). Similarly, the gland body component (14) will be restricted from rotating in an anti-clockwise (loosening) direction, as the gland body component (14) will lock up against the annular restriction (15) of the nut (16). Therefore, disassembly will only be possible if the nut is rotated in a loosening direction, towards the second end of the gland body component (14) until the thread of the nut (16) disengages with the thread of the entry component (12). It is this rotation which enables the partial disassembly of the cable gland (10).

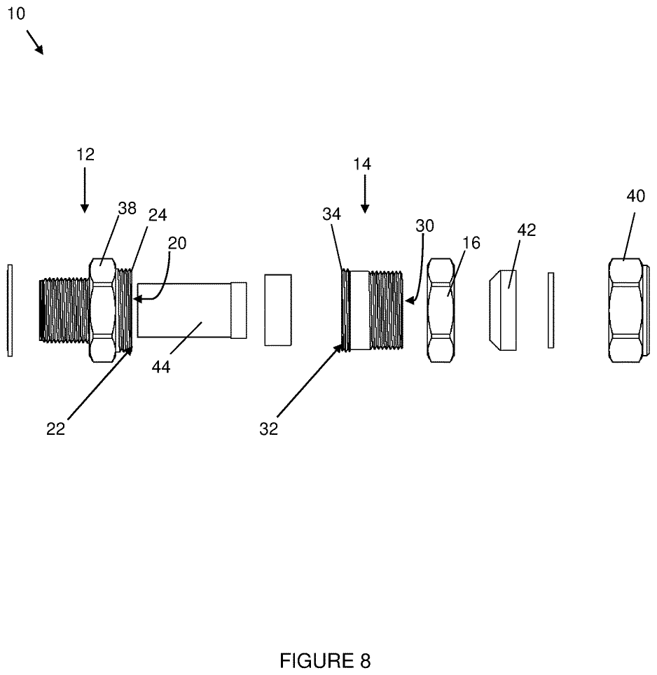

As shown most clearly in FIG. 2, in the illustrated embodiment the nut (16) has an axial dimension such that when the nut (16) is in the locked position, a width (17) of the nut (16) extends across the entirety of the threaded collar (32) of the second gland component (14) as well as the majority of the threaded collar (22) of the first gland component (12). In other embodiments this may not be the case, however the width of the nut will always be such that when the annular restriction butts against the predefined stop point of the gland body component it will extend across the entirety of the threaded collar of the second gland component and at least a part of the threaded collar of the first gland component. In use, when the threaded inner surface of the nut (16) engages with and extends along the threaded collar (32) of the gland body component (14), and the entry component (12) is aligned adjacent to the gland body component (14), continued rotation of the nut (16) will align the threaded collar (32) of the gland body component (14) with the threaded collar (22) of the entry component (12) to allow the nut (16) to continue to move along the threaded collars (22, 32) so as to secure the two component (12, 14) together. As illustrated in FIGS. 2 and 3, the cable gland (10) includes a sealing arrangement (43). The sealing arrangement (43) comprises a compression seal nut (40) and a compression seal (42). In other embodiments, the seal may not compress, but may rather seal by means of a suitable alternative method. The compression seal (42) is an elastomeric member which is configured to fit within the second end (35) of the tubular cavity (30) of the gland body component (14). As shown in FIG. 8, the compression seal (42) is annular in shape having a tapered configuration at one end. In alternate embodiments (not illustrated) the compression seal may not have a tapered configuration. In the illustrated embodiment, the tapered end is operatively inserted into the tubular cavity (30) of the gland body component, at the second end (35) thereof. The shape and size of the compression seal (42) is such that at the non-tapered end thereof has a diameter that is incrementally wider than that of the tubular cavity (30) of the gland body component (14). Therefore, the compression seal (42) may be easily inserted into the tubular cavity (30) until the non-tapered end thereof makes contact with inner surface of the tubular cavity (30) which offers a resistance against further inward movement.

As shown in FIGS. 7 and 8, the compression seal nut (40) is annular, having one side which includes a restriction member (45) facing radially inwards. As is described above, the compression seal nut (40) has a threaded internal surface which is configured to engage with threading on the second end (35) of the gland body component (14). In use, the compression seal nut (40) is engaged with the gland body component (14) such that the restriction member is faced away from the gland body component (14). The compression seal nut (40) is rotated such that the engaging threads result in movement of the compression seal nut (40) onto the second end (35) of the gland body component (14). Movement will occur until the restriction member (45) butts against the compression seal (42) and movement is restricted by compression of the compression seal (42). Compression of the compression seal (42) results in radial inward expansion thereof in known fashion. The compression seal nut (40) may be tightly screwed onto the gland body component (14) until the compression seal (42) can be compressed no further and the sealing arrangement (43) is in the locked configuration.

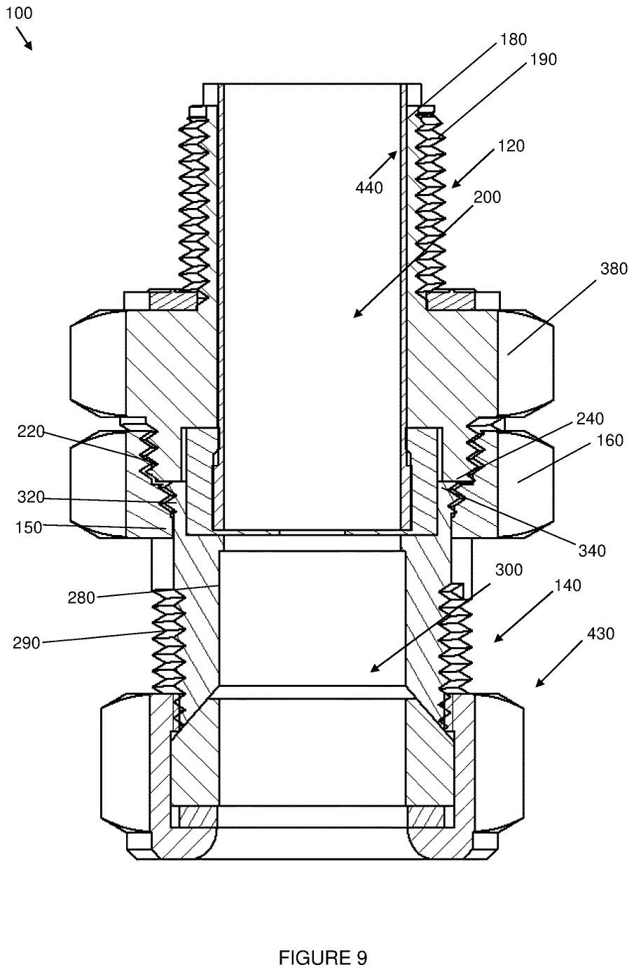

As shown in FIG. 9, in a second embodiment the cable gland (100) comprises a first gland component (120) and a second gland component (140). The first gland component is an entry component (120), and the second gland component is a gland body component (140). The entry component (120) has an inner surface (180) which defines an internal tubular cavity (200) configured to receive a cable and an outer surface (190) including a threaded portion (220) near a first end (240) thereof. The gland body component (140) also has an inner surface (280) defining a tubular cavity (300) configured to receive a cable and an outer surface (290) including a threaded portion or collar (320) near a first end (340) thereof. The cable gland (100) also includes a nut (160) dimensioned to slidably receive the entry component and gland body components (120, 140). The nut (160) includes a threaded inner surface. In this embodiment, the threaded inner surface includes two distinct threaded portions. The two threaded portions are distinguishable from each other in that the internal diameters thereof are different. The different threaded portions are configured to correspond to the threaded collars (220, 320) of the entry component (120) and the main gland component (140). In this embodiment, the threaded collar (220) of the entry component (120) has a larger external diameter than the threaded collar (320) of the main gland component (140). When the two first ends (240, 240) and the entry component (120) and the gland body component (140) are aligned and contacted, the different external diameters thereof result in a step. The configuration of the nut (160) allows for the nut to engage with the thread of the entry component (120) and the gland body component (140) in this embodiment where the threading of these two components (120, 140) differs.

In further embodiment, there may be further or alternate differences between the threading of the entry component (120) and the main gland component (140). For example, the threaded collars on these components (120, 140) may differ in the thread pitch, threads per inch, pitch diameter, flank angle and the like. In such embodiments, the distinct threaded portions of the nut will be configured to engage with the two different threaded collars.

In use, a cable (which may constitute a plurality of individually insulated conductors surrounded by an outer cable sheath) may extend through the internal cavities of the cable gland (10). The cable may be sealed within the cable gland (10) by tightening of the compression seal nut (40) and the resultant radial inward expansion of the compression seal (42). This inward expansion compresses against the cable held within the cable gland (10), resulting in the cable being locked within at least the main gland component (14) of the cable gland (10)

The cable gland (10) further includes a resin pot component (44) which is shaped and dimensioned to locate within the internal cavity (20) of the entry component (12) and the internal cavity (30) of the gland body component (14). As illustrated in FIG. 3, the resin pot component (44) includes a closable end (46) configured to seal onto a cable when the cable is secured within the cable gland. The resin pot component (44) is held within the internal cavity (30) of the gland body component (14) when the entry component (12) and gland body component (14) are disconnected, such that the resin pot component (44) is in an accessible position. The resin pot component (44) operatively receives a barrier material therein when it is in the accessible position. The barrier material may be a resin mix, however any other suitable barrier material may be used.

In use, the cable gland is assembled such that the entry component, fitted to a junction box or other electrical equipment, is locked to the main body component, the annular restriction of the nut butts against the predefined stop point of the gland body component and the compression seal arrangement is in an operatively locked configuration, such that a cable running through the cable gland is locked within the cable gland. The gland body component is prevented from rotating in the tightening direction because of the annular restriction of the nut butting against the threaded collar of the gland body component, and the first end of the gland body component butting against the first end of the entry component.

To partially disassemble the cable gland, the nut is rotated in an anti-clockwise (loosening) direction to disengage the thread of the nut with that of the entry component. The nut may also be rotated to such an extent that it is fully disengaged from the thread of both of the entry component and the gland body component. The gland body component and the entry component remain aligned and stationary during this process by virtue of the cooperation of the threads of the two components and the nut.

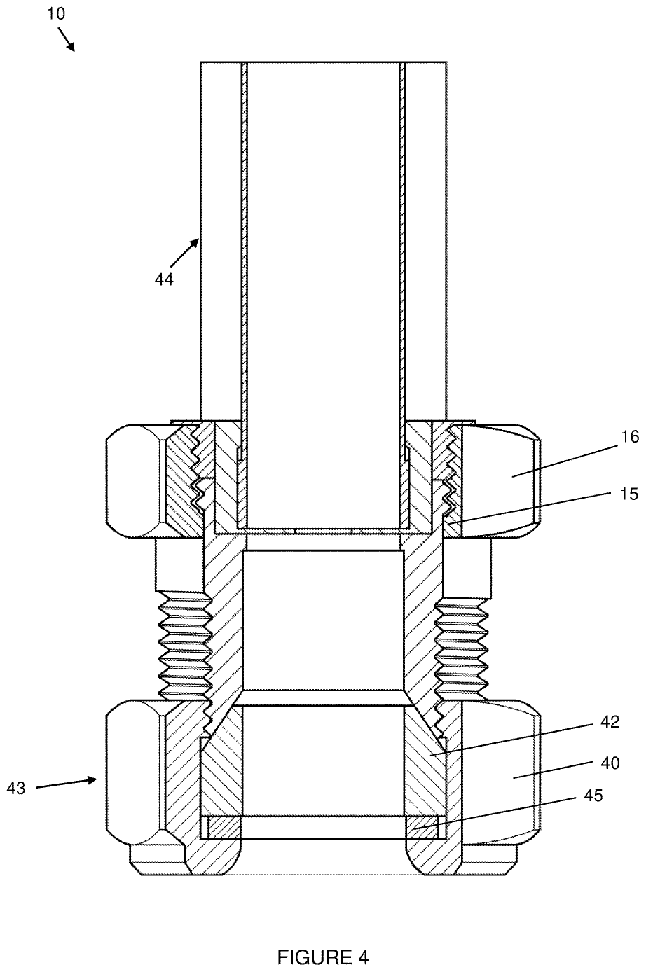

The gland body component can also be removed from the entry component whilst the nut remains partially threadedly engaged to the gland body component. During this separation, the gland body component remains locked to the cable due to the sealing arrangement such that the cable and the gland body component cannot rotate relative to each other. The gland body component and the cable can then be positioned vertically, as is illustrated in FIG. 4, to facilitate the insertion of the barrier material into the resin pot component, which may be in a liquid form.

Re-assembly is done by positioning the gland body component adjacent to the entry component and re-engaging the nut with the thread of both of the gland body component (if the nut was fully removed), and the thread of the entry component. The two components will automatically be realigned in the same angular position as they were before separation, due to the arrangement of the threading on these components.

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

In some embodiments, for example, the cable gland may be a cable gland for use with armoured electrical or fibre optic cables. In such embodiments, the cable gland may have an armour clamping arrangement including an armour clamping cone and cooperating armour clamping ring for securing, for example, the second gland component described herein to the cable by clamping wires of the armour between the armour clamping cone and armour clamping ring.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Finally, throughout the specification and accompanying claims, unless the context requires otherwise, the word ‘comprise’ or variations such as ‘comprises’ or ‘comprising’ will be understood to imply the inclusion of a stated integer or group of integers but not the exclusion of any other integer or group of integers.

1. A cable gland comprising:
a first gland component having an inner surface defining a tubular cavity configured to receive a cable and an outer surface including a threaded portion near a first end thereof;
a second gland component having an inner surface defining a tubular cavity configured to receive a cable and an outer surface including a threaded portion near a first end thereof;
a nut including a threaded inner surface wherein at least a portion of the threaded inner surface is configured to correspond to the thread on the first gland component and at least a portion of the threaded inner surface is configured to correspond to the thread on the second gland component;
wherein the first gland component is connectable to the second gland component by aligning and contacting the first end of the first gland component with the first end of the second gland component and engaging the thread of the nut with the thread of both of the gland components.

2. The cable gland as claimed in claim 1, wherein the nut includes a restriction adjacent to the threaded inner surface of the nut configured to engage with the second gland component.

3. The cable gland as claimed in claim 2, wherein the restriction is an annular restriction.

4. The cable gland as claimed in claim 2, wherein the restriction is located at an end of the nut which is configured to engage with the second gland component, and wherein the restriction is configured to prevent the nut from being rotated beyond a predefined point of the second gland component.

5. The cable gland as claimed in claim 1, wherein the configuration of the threading of the second gland component is such when the nut is engaged therewith axial rotation of the nut results in movement of the nut relative to the first end of the threaded portion of the second gland component.

6. The cable gland as claimed in claim 2, wherein the threaded portion of the second gland component is configured to be a threaded collar having a diameter that is greater than a diameter of a portion of the second gland component which is positioned adjacent to the threaded collar such that the threaded collar is raised relative to the adjacent portion of the second gland component.

7. The cable gland as claimed in claim 6, wherein the restriction of the nut may be configured to have an internal diameter which is less than that of the threaded collar of the second gland component and greater than that of the adjacent portion of the second gland component such that the restriction prevents movement of the nut in the direction of the first end of the second gland component when the restriction butts against the threaded collar.

8. The cable gland as claimed in claim 1, wherein the nut is configured to engage with and extend along the entirety of the threaded portion of the second gland component and at least a part of the threaded portion of the first gland component thereby securing the first gland component and the second gland component together.

9. The cable gland as claimed in claim 1, wherein the sum of the axial dimension of the threaded portion of the first gland component and the axial dimension of the threaded portion of the second gland component is greater than the axial dimension of the threaded inner surface of the nut.

10. The cable gland as claimed in claim 1, wherein the cable gland includes a seal nut which cooperates with a seal to secure a cable within the tubular cavity of the second gland component, wherein the cable and the second gland component become locked relative to each other when the outer seal is tightened.

11. The cable gland as claimed in claim 10, wherein the seal nut is a compression seal nut and the seal is a compression seal such that compression of the compression seal results in radial inward expansion thereof.

12. The cable gland as claimed in claim 10, wherein the cable gland includes a resin pot component, the resin pot component being shaped and dimensioned to locate within the internal cavities of the first and second gland components and having a closable end configured to seal onto a cable when the cable is secured within the cable gland.

13. The cable gland as claimed in claim 1, wherein rotation of the nut in a loosening direction results in a disengagement of the nut with the threading of the first gland component to result in a disconnection between the first gland component and the second gland component.

14. The cable gland as claimed in claim 12, wherein the resin pot component is held within the internal cavity of the second gland component when the first and second gland components are disconnected, such that the resin pot component is in an accessible position.

15. The cable gland as claimed in claim 13, wherein the resin pot component operatively receives a barrier material therein when in the accessible position.

16. (canceled)

17. The cable gland as claimed in claim 1, wherein the first gland component is an entry component, and the second gland component is a gland body component.

18. The cable gland as claimed in claim 17, wherein the entry component includes a protrusion configured to facilitate movement of the entry component.

19. The cable gland as claimed in claim 1, wherein an outer surface of the nut forms a hexagonal shape to facilitate rotation thereof.

20. The cable gland as claimed in claim 18, wherein an outer surface of the protrusion forms a hexagonal shape to facilitate rotation thereof.

21. The cable gland as claimed in claim 1, wherein the portion of the threaded inner surface of the nut configured to correspond to the thread of the first gland component is a continuation of the portion of the threaded inner surface of the nut configured to correspond to the thread of the second gland component such that the two threaded portions of the nut together comprise a continuous threaded inner surface.

22-23. (canceled)
